(19) United States
(12) Patent Application Publication
(10) Pub. No.: US 2010/0143856 A1
(43) Pub. Date: Jun. 10, 2010

(54) PLACEMENT JIG FOR AN ORTHODONTIC DEVICE

(75) Inventor: Göran Steen, Hovås (SE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Gestenco International AB, Goteborg (SE)

(21) Appl. No.: 12/308,262

(22) PCT Filed: Jun. 9, 2006
(86) PCT No.: PCT/SE2006/000673

§ 371 Date: Dec. 7, 2009

(51) Int. Cl. A61C 7/28

(52) U.S. Cl. 433/10

(57) ABSTRACT

The present invention relates to orthodontic devices, e.g. dental brackets and the like equipment, intended to be attached to a tooth and in particular to the positioning and handling of equipment intended to be fastened to the tooth. According to the invention, the orthodontic device (1) comprises a component (3) adapted to be attached to a tooth and a placement jig (2) wherein said placement jig (2) is an integral part of said component (3) and attached to said component (3) at a connection (9). The connection (9) is adapted to be easily disconnected when the component (3) is attached to the tooth. In still a further aspect of the invention, it relates to an orthodontic device provided with a holding stick (11) which may serve the purpose of aiding in positioning the orthodontic device (1) or, in case of a self ligating bracket (3), being an aid in opening a lid (5). The invention is in particular useful for orthodontic devices to be placed at the lingual side of a tooth.

### FIELD OF THE INVENTION

The present invention relates to dental brackets and the like equipment intended to be attached to a tooth. In particular the invention relates to such equipment which is intended to be fastened at the lingual side of the tooth and the positioning and handling of such equipment.

### BACKGROUND OF THE INVENTION

Positioning of dental or orthodontic brackets of various types on the teeth of a patient for correcting various irregularities is well known in the dental art. In older work, these brackets comprised a band to be placed around the teeth whereby each band were equipped with a protuberance to which wires and bands could be attached in order to link the system. Nowadays, brackets are commonly attached by cementing the base of the bracket where needed to the face of the teeth and thereby eliminating the need for bands encircling the teeth.

In recent time, the use of self ligating orthodontic brackets has become more common. These brackets include a bracket base and a ligation cover which interacts with the base in order to provide ligation of an arch wire associated with the base. Such brackets are described in for example U.S. Pat. No. 6,655,957, U.S. Pat. Nos. 6,659,766 and 6,659,767. These brackets are usually provided with a locking mechanism which prevents the lid from opening when it is in its closed, ligating position. However, these brackets may be hard to open up sometimes and the better the closing is, the harder they are to open up. In particular for lingual brackets, which are harder to work with when located on the tooth, it might be a problem to open when desired. Hence, there is a need for making an improved arrangement for handling a bracket, in particular lingual brackets, which serves the purpose of making the open up of a closed self ligating bracket easier.

### SUMMARY OF THE INVENTION

In accordance with the present invention, a self ligating bracket has been invented, comprising a body portion and a lid pivotally connected to the body portion, the lid comprising a holding stick extending from the surface of the lid. In accordance with one embodiment, the lid comprises a covering section and a closing section, the covering section being pivotally connected to the body portion, and the covering section and the closing section being angled with respect to each other, the closing section being provided with a holding stick. In a preferred embodiment, the holding stick comprises a hook portion.

The present invention relates to a method and system for opening and closing the lid of a self ligating bracket. According to the present invention the lid comprises a holding stick extending from the surface of the lid. The purpose of the stick is to allow a tool to get a grip around the stick and effectuating a force on the stick which in turn forces the lid to open.

In one embodiment of the present invention, the lid comprises a covering section and a closing section. The covering section is pivotally connected to the main portion and the covering section and the closing section are angled with respect to each other. The closing section is provided with the holding stick. In this embodiment, the angled portion will allow a good support for the tool to brace against so as to effectuate a force enough to open the lid.

In order to get a better grip, the stick may be provided with a hook, protrusion or indentation in order to allow a tool, e.g. a fork or a small rod provided with a loop at its end, to get a better grip on the stick.

According to another embodiment of the present invention, the stick may also be used as a holding stick when positioning the orthodontic device in order to get a better grip of the orthodontic device so as to improve the secure positioning of the orthodontic device when it is attached to a tooth. According to this embodiment, the stick may be placed on any kind of orthodontic device in order to improve the positioning of the device and not only on a self ligating bracket.

By the expression “orthodontic device” in this context is meant brackets, tubes, bite ramps or the like devices which are intended to be attached to the tooth for orthodontic treatment.

### BRIEF DESCRIPTION OF THE DRAWINGS

The present invention will be further described in the following detailed description, with reference to the annexed drawings, in which

FIG. 1 is a side, plan view of a bracket according to the present invention;

FIG. 2 is a side, elevational view of the bracket shown in FIG. 1; and

FIG. 3 is a top, elevational view of the bracket shown in FIG. 1.

### DETAILED DESCRIPTION

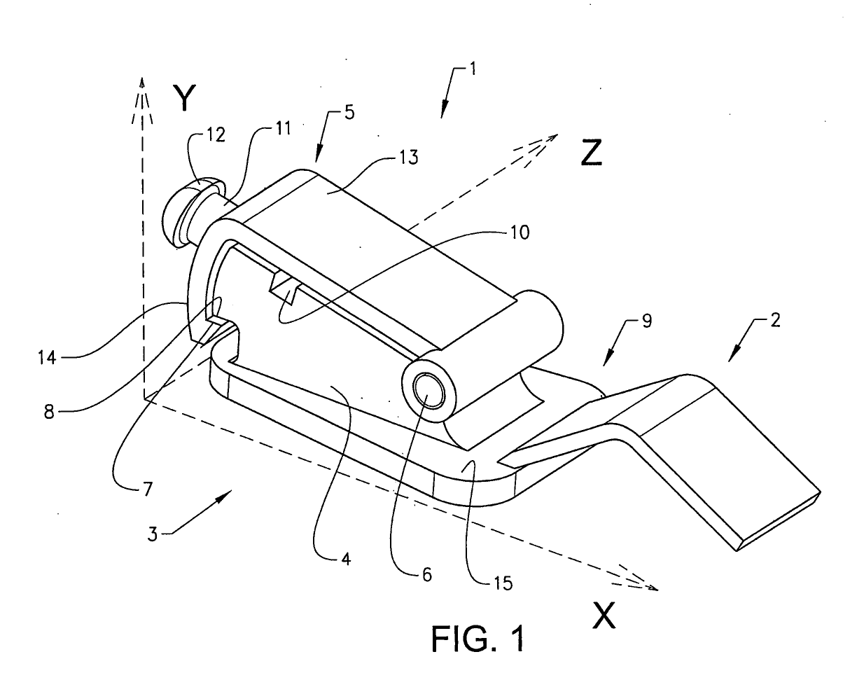

In FIGS. 1-3, there are some times used general directions or locations. The up- and down direction is defined as the Y-direction wherein the underside is the side of the device intended to be attached to a tooth and the upper side is the side facing away from the tooth when attached on a tooth. The longitudinal direction, or the length direction, is defined as the X-direction and the lateral direction, or width direction, is defined as the Z-direction.

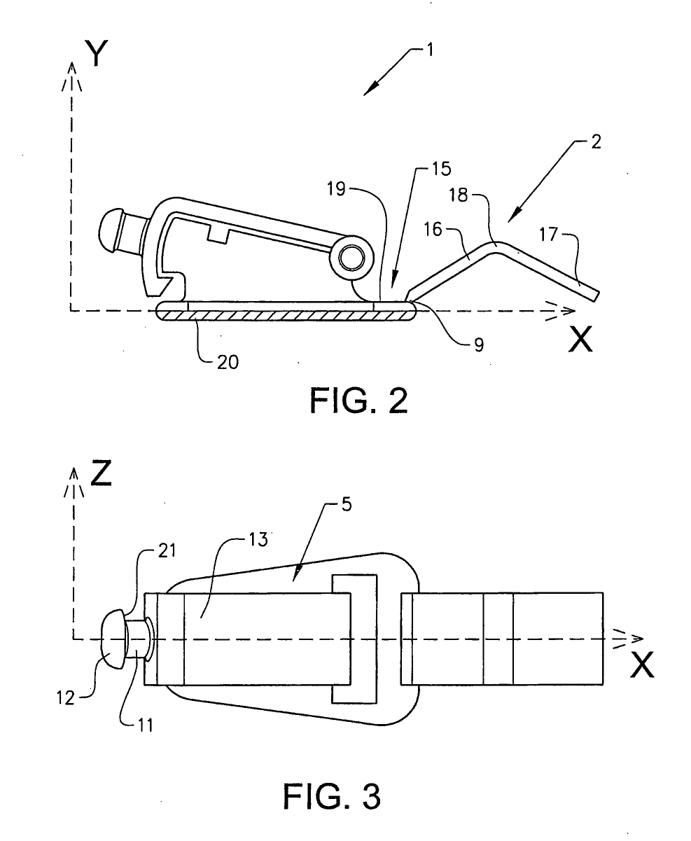

FIG. 1 shows a perspective view of an orthodontic device 1 according to the present invention. The orthodontic device comprises a placement jig 2 and a bracket 3 adapted to be attached to a tooth. The bracket 3, which in this case is a self ligating bracket, comprises a main component 4 and a lid 5. The lid 5 is pivotally connected to the main component 4 by means of a hinge 6. The bracket 3 is shown in its closed position wherein the distal end of the lid 4 is formed as a hook 7 which is adapted to engage with a shoulder 8 formed by an edge part of the main component 4. Between the bracket 3 and the jig 2 is a connection 9. The requirements of this connection is that it is rigid enough to ensure that the placement of the bracket 3 at the desired location may be performed in a satisfactorily way while at the same time be adapted to be easily broken, e.g. by bending of the jig 2 back and forth a couple of times so as to weakening the connection 9 where after the jig 2 can be detached from the bracket 3 when the bracket 3 is attached to a tooth. The main component 4 of the bracket 3 further comprises a slot 10 adapted to receive a wire or the like in order to connect brackets attached to different teeth and thereby providing an orthodontic treatment of the teeth. The lid 4 further comprises a protruding holding stick 11. The stick 11 comprises a ball end hook 12 which cross section is larger than the cross section of the stick 11 as seen along the length of the stick 11. The important feature of the hook 12 is that it is protruding on the sides of the stick 11 as can be better seen in FIG. 2. By this protruding part it will be able to disengage the lid 4 from its closed position to an open position in an easy manner as will be explained later on. The lid can be divided in two sections: a first covering section 13 which is adapted to cover the slot 10 and a closing section 14 which is provided with the closing hook 7 at its end. The stick 11 with its attached ball end hook is preferably attached to the closing section 14 of the lid 4. In this way, a tool adapted to engage with the hook, e.g. a fork shaped tool, may use the edge part of the lid 4 created at the bend of the lid between the covering section 13 and the closing section 14 to brace against so as to move the closing hook in an upwards and outwards direction in order to disengage the closing hook 7 from the shoulder 8. The bracket 3 further comprises a base plate 15 which is provided with an adhesive on its underside when the bracket is to be attached to a tooth.

In FIG. 2, which is a side view of the orthodontic device 1 shown in FIG. 1, the bent shape of the placement jig 2 can be clearly seen. The jig may be divided into two portions: a first attachment portion 16 and a second indicating portion 17 divided by a bend 18. The angle of the bend 18 between the first portion 16 and the second portion 17 is around 60 degrees in this embodiment.

FIG. 3 is the best figure to show how the principles of the holding stick 11. As can be seen in this view, the ball end hook 12 is wider than the stick so that an edge is created between the stick 11 and the ball end hook 12. When the edge is formed as shown in this figure, it would be easy to use a fork shaped tool in order to open the lid 5. The distance between two of the prongs of the fork shall be larger than the width of the stick 11 but narrower than the width of the part of the ball end hook creating the edge 21. The ball end stick 12 may of course be wider, or having a larger diameter, than the stick 11 in all directions but when using a fork shaped tool for opening of the lid, the essential feature is that the ball end hook 12 is wider in the Z-direction as shown in FIG. 3.

Now mainly referring to FIG. 1, the opening of the lid will be explained. When opening the lid 5, the fork is placed on top of the lid 5 with the stick 11 located between a pair of tongs of the fork tool in such a way that the tongs engages with the edge parts 21 (see FIG. 3) at each side of the stick 11 as seen in the width direction (Z-direction). The handle of the fork is pressed downwards whereby the fork braces against the bend of the lid 4 (i.e. the part defined between the covering section 13 and the closing section 14). The fork work as a lever arm and will cause a force to work through the stick 11 on the closing section 14 of the lid, and thus the closing hook 7, in such a way that the hook 7 moves away from the shoulder 8.

However, other tools might be used which works according to the same principle, e.g. a loop formed tool or the like, which may be threaded over the ball end hook and engage with the stick. In that case, it would be preferable to have a hook with a protruding edge on the lower side of the stick in the Y-direction as defined in the figures so as to form an edge there which engages with the loop shaped tool. Hence, there are several possibilities of shaping tools adapted to fit for hooks on a disengaging stick in one or the other way. It shall also be noted that a hook on the stick may as well be made as an indentation, cut, notch or the like as well as other type of hooks, e.g. an eye hook, barb or any other suitable hook.

Furthermore, the tool may be adapted to get a grip on a plain stick why it is not necessary to provide the stick with any hook at all. However, this implies that a more advance tool having moving parts, e.g. a pair of tongs, might be needed.

The invention is not limited to the embodiments which is described above, but may be varied within the scope of the appended claims.

In particular, it shall be noted that the figures only refers to self ligating brackets. It would of course also be possible to use this method for other kinds of brackets or orthodontic devices as well.

It shall also be noted that the placement jig and the holding stick not necessary must be used on the same device but may be used separately, the holding stick may be used on a self ligating bracket which is not provided with the placement jig.

However, these two features combined make the bracket easier to position and handle and it is preferred to incorporate these two features on the same device. As already described, there is a synergistic effect of using them together in that the stick may be used to hold the orthodontic device in a desired position while the jig is used to indicate the desired position.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1-32. (canceled)

33. A self ligating bracket comprising a body portion and a lid pivotally connected to said body portion, said lid comprising a holding stick extending from the surface of said lid.

34. A self ligating bracket according to claim 33, wherein said lid comprises a covering section and a closing section, said covering section being pivotally connected to said body portion, and said covering section and said closing section being angled with respect to each other, said closing section being provided with a holding stick.

35. A self ligating bracket according to claim 33, wherein said holding stick comprises a hook portion.
